(19) United States
(12) Patent Application Publication
(10) Pub. No.: US 2012/0042313 A1
(43) Pub. Date: Feb. 16, 2012

(54) SYSTEM HAVING TUNABLE PERFORMANCE, AND ASSOCIATED METHOD

(76) Inventors: Weng-Hang Tam, Macao (MO); Yong-Sheng Lo, Taichung City (TW)

(21) Appl. No.: 12/855,707

(22) Filed: Aug. 13, 2010

(51) Int. Cl. G06F 9/46; G06F 1/00

(52) U.S. Cl. 718/100; 713/100; 713/322

(57) ABSTRACT

A system having tunable performance includes: a plurality of units, wherein at least one unit includes a hardware circuit; at least one global/local busy level detector including at least one global busy level detector and/or at least one local busy level detector, wherein each global/local busy level detector is arranged to detect a global/local busy level of at least one portion of the units; and a global/local system performance manger arranged to tune the performance of the system according to at least one global/local busy level detected by the at least one global/local busy level detector, wherein based upon the at least one global/local busy level and at least one policy associated with the performance of the system, the global/local system performance manger adjusts at least one parameter of the system when needed, and the parameter corresponds to the performance of the system. An associated method is also provided.

### BACKGROUND

The present invention relates to performance tuning of a system, and more particularly, to a system having tunable performance, and to an associated method.

Power saving is always an important issue for implementation of electronic devices such as mobile phones, personal or portable navigation devices (PNDs), digital cameras, personal computers, etc., no matter whether the electronic devices are portable or not. In order to reduce the power consumption of the electronic devices, and more particularly, those powered by batteries, conventional methods of the related art typically focus on sacrificing performance for power saving. However, when products are implemented based upon the conventional methods, many problems may occur. For example, non-smooth playback of music may occur when a conventional product operates in a power saving mode. In another example, no matter whether the electric power is sufficient or not, due to the goal of power saving, a conventional product may suffer from poor audio playback performance when it is powered by a battery, causing inconvenience to users. Thus, the related art does not serve the users well, and therefore, a novel method is required to improve performance control of the electronic devices.

### SUMMARY

It is therefore an objective of the claimed invention to provide a system having tunable performance, and to provide an associated method, in order to solve the above-mentioned problems.

An exemplary embodiment of a system having tunable performance comprises: a plurality of units, wherein at least one unit of the plurality of units comprises a hardware circuit; at least one global/local busy level detector comprising at least one global busy level detector and/or at least one local busy level detector, wherein each global/local busy level detector is arranged to detect a global/local busy level of at least one portion of the units; and a global/local system performance manger arranged to tune the performance of the system according to at least one global/local busy level detected by the at least one global/local busy level detector, wherein based upon the at least one global/local busy level and at least one policy associated with the performance of the system, the global/local system performance manger adjusts at least one parameter of the system when needed, in order to save power and/or guarantee operations of the system, and the at least one parameter corresponds to the performance of the system.

An exemplary embodiment of a method for tuning performance of a system comprises: detecting at least one global/local busy level of at least one portion of a plurality of units of the system, wherein at least one unit of the plurality of units comprises a hardware circuit; and tuning the performance of the system according to the at least one global/local busy level. In addition, the step of tuning the performance of the system according to the at least one global/local busy level further comprises: based upon the at least one global/local busy level and at least one policy associated with the performance of the system, adjusting at least one parameter of the system when needed, in order to save power and/or guarantee operations of the system, wherein the at least one parameter corresponds to the performance of the system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system having tunable performance according to a first embodiment of the present invention.

FIG. 2 is a flowchart of a method for tuning performance of a system according to one embodiment of the present invention.

FIGS. 3A-3E illustrate some implementation details of the system shown in FIG. 1 according to some embodiments of the present invention.

FIG. 4 illustrates some implementation details of the system shown in FIG. 1 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

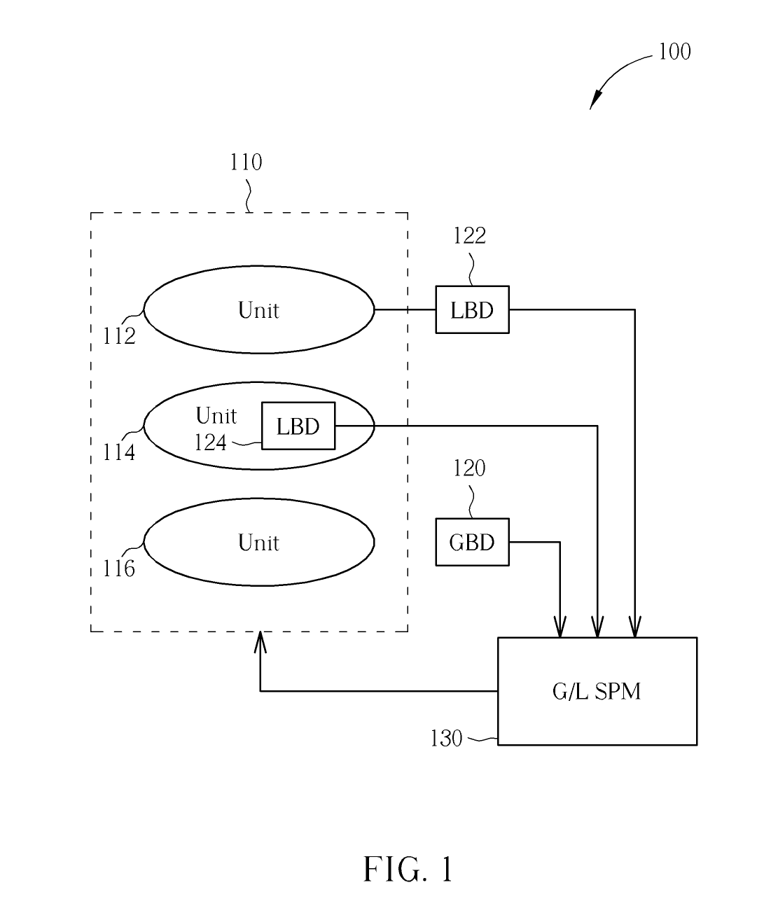

Please refer to FIG. 1, which illustrates a diagram of a system 100 having tunable performance according to a first embodiment of the present invention. For example, the system 100 can be a symmetric multiprocessing (SMP) system or an asymmetric multiprocessing (AMP) system. The system 100 comprises: a plurality of units 110 comprising the units 112, 114, and 116; at least one global/local busy level detector comprising at least one global busy level detector and/or at least one local busy level detector, such as the global busy level detector 120 (labeled “GBD” in FIG. 1) and the local busy level detectors 122 and 124 (respectively labeled “LBD” in FIG. 1); and a global/local system performance manger 130 (labeled “G/L SPM” in FIG. 1). In this embodiment, at least one unit of the plurality of units 110 comprises a hardware circuit. More particularly, at least one unit of the plurality of units 110 comprises a software module. For example, some of the units 110 can be hardware circuits, and some of the units 110 can be software modules. In addition, a global/local busy level detector of this embodiment, such as any of the global busy level detector 120 and the local busy level detectors 122 and 124, can be implemented with a hardware circuit or a software module, or can be implemented with a combination of a hardware circuit and a software module. Similarly, the global/local system performance manger 130 can be implemented with a hardware circuit or a software module, or can be implemented with a combination of a hardware circuit and a software module. Please note that, in this embodiment, the system 100 can be a SMP system or an AMP system. This is for illustrative purposes only, and is not meant to be a limitation of the present invention. According to some variations of this embodiment, the system 100 can be a distributed system. For example, the distributed system may comprise a plurality of personal computers (PCs), where each PC can be regarded as one of the units 110. More particularly, for the PCs, a plurality of local busy level detectors can be arranged to detect a plurality of local busy levels corresponding to the PCs, respectively. According to some variations of this embodiment, the system 100 may comprise a plurality of virtual machines executing respective operating systems (OSs), where each virtual machine can be regarded as one of the units 110. More particularly, for the virtual machines, a plurality of local busy level detectors can be arranged to detect a plurality of local busy levels corresponding to the virtual machines, respectively. In addition, within the system 100 comprising the virtual machines in these variations, a PC running the virtual machines may be equipped with a global busy level detector such as that shown in FIG. 1.

According to this embodiment, each global/local busy level detector (e.g. the global busy level detector 120, or any of the local busy level detectors 122 and 124) is arranged to detect a global/local busy level of at least one portion of the units 110, such as one or more of the units 110 or all of the units 110, where a global/local busy level detector can be positioned outside a unit or within a unit. For example, the global busy level detector 120 of this embodiment can be arranged to detect a global busy level of the aforementioned at least one portion of the units 110 and can be positioned outside the units 110, and the local busy level detector 122 of this embodiment can be arranged to detect a local busy level of the unit 112 and can be positioned outside the unit 112. In another example, the local busy level detector 124 can be arranged to detect a local busy level of the unit 114 and can be positioned within the unit 114. In some variations of this embodiment, any of the units, such as the unit 112, can be passively under detection of the local busy level detector, such as the local busy level detector 122, and can be not aware of it. In some variations of this embodiment, any of the units, such as the unit 114, can actively report its busy level to the local busy level detector, such as the local busy level detector 124. According to a case of this embodiment, the unit 114 may be equipped with control ability over the local busy level detector 124. According to another case of this embodiment, the unit 114 may utilize the local busy level from the local busy level detector 124.

In addition, the global/local system performance manger 130 of this embodiment is arranged to tune the performance of the system 100 according to at least one global/local busy level detected by the aforementioned at least one global/local busy level detector. Based upon the aforementioned at least one global/local busy level and at least one policy associated with the performance of the system 100, the global/local system performance manger 130 can adjust at least one parameter of the system 100 when needed, in order to save power and/or guarantee operations of the system 100, where the aforementioned at least one parameter corresponds to the performance of the system 100. More particularly, the aforementioned at least one parameter may comprise at least one operation frequency of the system 100. Based upon the aforementioned at least one global/local busy level and the aforementioned at least one policy, the global/local system performance manger 130 can decrease the aforementioned at least one operation frequency of the system 100 when needed, in order to save power. For example, in a situation where the system 100 is powered by a battery, when it is detected that the battery power is below a threshold, the global/local system performance manger 130 can decrease the operation frequency of the system 100 to save power. Based upon the aforementioned at least one global/local busy level and the aforementioned at least one policy, the global/local system performance manger 130 can increase the aforementioned at least one operation frequency when needed, in order to guarantee operations of the system 100, and more particularly, at least one portion of the units 110, such as a portion or all of the units 110. For example, in a situation where the units 110 include a media player and non-smooth playback of music by the media player is found, the global/local system performance manger 130 can increase the operation frequency of the media player to guarantee smooth playback of music.

Although the aforementioned at least one global/local busy level detector comprises at least one global busy level detector (e.g. the global busy level detector 120) and at least one local busy level detector (e.g. the local busy level detectors 122 and 124), this by no means implies that the global/local system performance manger 130 should always utilize the global/local busy level from each global/local busy level detector. In addition, this by no means implies that both the global busy level detector and the local busy level detector should be adopted in the system 100. In practice, a local busy level detector of the aforementioned at least one global/local busy level detector can be temporarily or permanently disabled, and/or the global/local system performance manger 130 can temporarily or permanently operate without utilizing any local busy level from the local busy level detector. Similarly, a global busy level detector of the aforementioned at least one global/local busy level detector can be temporarily or permanently disabled, and/or the global/local system performance manger 130 can temporarily or permanently operate without utilizing any global busy level from the global busy level detector.

In particular, the aforementioned at least one policy may comprise a plurality of policies, and in accordance with at least a portion of the policies, such as a portion or all of the policies, the global/local system performance manger 130 dynamically keeps the operation frequency at an optimal value thereof. For example, the global/local system performance manger 130 may dynamically keep the operation frequency at a first optimal value thereof at a first time period, and dynamically keep the operation frequency at a second optimal value thereof at a second time period. As a result, the global/local system performance manger 130 can give consideration to both the performance and the power consumption of the system 100.

Please note that, in this embodiment, changing the aforementioned at least one operation frequency may affect both the performance of the unit 112 and the performance of the unit 114, so the units 112 and 114 can be regarded as system performance dependent units (SPDUs) since each of their own performance is tunable. Thus, both the performance of the unit 112 and the performance of the unit 114 can be under control of the global/local system performance manger 130. On the contrary, changing the aforementioned at least one operation frequency may not affect the performance of the unit 116, so the unit 116 can be regarded as a system performance independent units (SPIU) since its own performance is not tunable. Thus, the performance of the unit 116 can be not under control of the global/local system performance manger 130. In particular, an SPIU such as the unit 116 may have its own operation frequency, which is independent of the aforementioned at least one operation frequency. This is for illustrative purposes only, and is not meant to be a limitation of the present invention. According to some variations of this embodiment, in a situation where the global/local system performance manger 130 manages global/local system performance by changing respective bandwidths of the units, rather than changing the aforementioned at least one operation frequency, an SPIU such as the unit 116 may have the same operation frequency as that of the system 100.

According to some variations of this embodiment, no matter whether any of the number of units, the number of SPDUs, the number of SPIUs, the number of global busy level detectors, and the number of local busy level detectors within the system 100 changes or not, the aforementioned at least one policy, such as one or more policies, may still cause the performance of the system 100 to be properly tuned. In practice, with regard to a specific unit of the units 110, the global/local system performance manger 130 may determine a required value of the operation frequency for the specific unit, where the required value corresponding to the specific unit represents the basic requirement of the value of the operation frequency for the specific unit to operate properly. For example, in a situation where the specific unit represents a software module such as an audio playback application (e.g. a media player), the required value corresponding to the specific unit represents the basic requirement of the value of the operation frequency for the audio playback application to play music smoothly. Similarly, with regard to the units 110, the global/local system performance manger 130 may determine required values of the operation frequency for the units 110, respectively. As the required values respectively corresponding to the units 110 represent respective basic requirements for the units 110, the global/local system performance manger 130 can perform performance management on the units 110 based upon at least a portion (e.g. a portion or all) of the required values respectively corresponding to the units 110.

According to one of these variations, in accordance with at least a portion of the aforementioned at least one policy, the global/local system performance manger 130 temporarily keeps the operation frequency at a target value, where the target value is a maximum of respective required values of the operation frequency for at least a portion of the units 110 (e.g. a portion or all of the units 110). For example, the local busy level from the local busy level detector 122 indicates that the required value of the operation frequency for the unit 112 is equal to a first value, and the local busy level from the local busy level detector 124 indicates that the required value of the operation frequency for the unit 114 is equal to a second value, where the global busy level from the global busy level detector 120 indicates that the required value of the operation frequency for the units 110 is equal to a third value. Please note that the required value of the operation frequency for the units 110 can be utilized as the required value of the operation frequency for the unit 116. That is, given that the required value of the operation frequency for the units 110 is equal to the third value, the required value of the operation frequency for the unit 116 can also be equal to the third value. In a situation where the third value is less than any of the first and the second values with the second value being greater than the first value, the global/local system performance manger 130 utilizes the second value as the target value. As a result, the global/local system performance manger 130 can guarantee operations of each of the units 112, 114, and 116. Therefore, the related art problems, such as sacrificing performance (e.g. the performance of the unit 114) for saving power, will never occur.

According to another of these variations, in accordance with at least a portion of the aforementioned at least one policy, the global/local system performance manger 130 temporarily keeps the operation frequency at a target value, where the target value is a sum of respective required values of the operation frequency for at least a portion of the units 110, such as a portion or all of the units 110. For example, in a situation where the local busy level from the local busy level detector 122 indicates that the required value of the operation frequency for the unit 112 is equal to a fourth value and the local busy level from the local busy level detector 124 indicates that the required value of the operation frequency for the unit 114 is equal to a fifth value, the global/local system performance manger 130 utilizes the sum of the fourth value and the fifth value as the target value. In another example, in a situation where the local busy level from the local busy level detector 122 indicates that the required value of the operation frequency for the unit 112 is equal to a sixth value and the local busy level from the local busy level detector 124 indicates that the required value of the operation frequency for the unit 114 is equal to a seventh value, and the global busy level detector 120 indicates that the required value of the operation frequency for the units 110, and more particularly, for the unit 116, is equal to an eighth value, the global/local system performance manger 130 utilizes the sum of the sixth value, the seventh value, and the eighth value as the target value. As a result of properly estimating the target value by utilizing the sum of the respective required values of the operation frequency for at least a portion of the units 110, the global/local system performance manger 130 can guarantee operations of each of the units 112, 114, and 116. Therefore, the related art problems, such as sacrificing performance for saving power, will never occur.

According to another of these variations, in accordance with at least a portion of the aforementioned at least one policy, the global/local system performance manger 130 can temporarily minimize power consumption of the units 110 without hindering operations of at least a portion of the units 110 (e.g. a portion or all of the units 110). For example, the global/local system performance manger 130 temporarily decreases the operation frequency to a minimal value available, as long as the operations of at least a portion of the units 110 (e.g. a portion or all of the units 110) are not hindered. This is for illustrative purposes only, and is not meant to be a limitation of the present invention. According to another of these variations, in accordance with at least a portion of the aforementioned at least one policy, the global/local system performance manger 130 can temporarily minimize power consumption of the units 110 without severely hindering operations of at least a portion of the units 110 (e.g. a portion or all of the units 110). For example, the global/local system performance manger 130 temporarily decreases the operation frequency to a minimal value available, as long as the operations of at least a portion of the units 110 (e.g. a portion or all of the units 110) are not severely hindered. According to another of these variations, in accordance with at least a portion of the aforementioned at least one policy, the global/local system performance manger 130 can temporarily keep the operation frequency at a maximal value available. For example, the global/local system performance manger 130 temporarily increases the operation frequency to a maximal value available, in order to achieve the required performance.

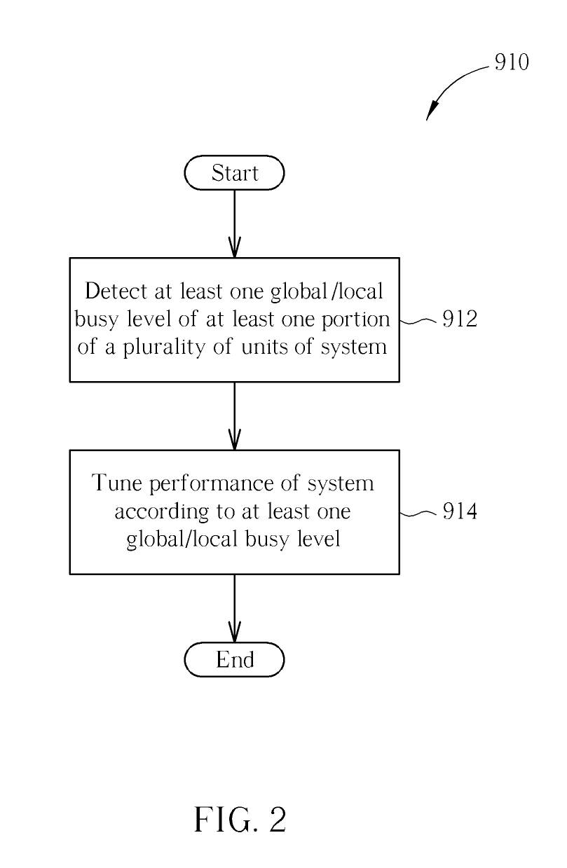

FIG. 2 is a flowchart of a method 910 for tuning performance of a system according to one embodiment of the present invention. The method can be applied to the system 100 shown in FIG. 1, and more particularly, to the global/local busy level detectors 120-124 (labeled “GBD”/“LBD” in FIG. 1) and/or the global/local system performance manger 130 (labeled “G/L SPM” in FIG. 1) mentioned above. In addition, the method can be implemented by utilizing the system 100 shown in FIG. 1, and more particularly, by utilizing the global/local busy level detectors 120-124 and/or the global/local system performance manger 130 mentioned above. The method 910 is described as follows.

In Step 912, the aforementioned at least one global/local busy level detector detects at least one global/local busy level of at least one portion of a plurality of units of the system 100, such as at least one portion of the units 110 mentioned above. In particular, the global busy level detector 120 (labeled “GBD” in FIG. 1) can detect the global busy level of the aforementioned at least one portion of the units 110, and the local busy level detectors 122 and 124 (respectively labeled “LBD” in FIG. 1) can detect the local busy levels of the units 112 and 114, respectively.

In Step 914, the global/local system performance manger 130 tunes the performance of the system 100 according to the aforementioned at least one global/local busy level. In particular, based upon the aforementioned at least one global/local busy level and at least one policy associated with the performance of the system 100, the global/local system performance manger 130 adjusts at least one parameter of the system 100 when needed, in order to save power and/or guarantee operations of the system 100, where the aforementioned at least one parameter corresponds to the performance of the system 100.

More particularly, the at least one parameter mentioned in Step 914 may comprise at least one operation frequency of the system 100, such as the aforementioned at least one parameter in the embodiment shown in FIG. 1. Based upon the aforementioned at least one global/local busy level and the aforementioned at least one policy, the global/local system performance manger 130 decreases at least one operation frequency of the system 100 when needed, in order to save power. For example, when a global/local busy level reaches a predetermined threshold, the global/local system performance manger 130 may determine that decreasing the operation frequency is needed, where the predetermined threshold may be associated with one or more policies. In addition, based upon the aforementioned at least one global/local busy level and the aforementioned at least one policy, the global/local system performance manger 130 increases the operation frequency when needed, in order to guarantee operations of the system 100, and more particularly, at least one portion of the units 110. For example, when a global/local busy level reaches a predetermined threshold, the global/local system performance manger 130 may determine that increasing the operation frequency is needed, where the predetermined threshold may be associated with one or more policies. This is for illustrative purposes only, and is not meant to be a limitation of the present invention. According to some variations of this embodiment, the at least one parameter mentioned in Step 914 may comprise at least one bandwidth of the at least one portion of the units 110. More particularly, the at least one bandwidth may correspond to time of using a central processing unit (CPU) within the system 100 by the at least one portion of the units 110, respectively.

According to this embodiment, the global busy level can be obtained from various kinds of detections. For example, the global busy level may correspond to an idle time of at least one CPU (e.g. in Step 912, the aforementioned at least one portion of the plurality of units of the system 100 comprises the CPU), and more particularly, may correspond to at least one idle duration (e.g. one or more idle durations) of an idle task virtually executed by the CPU. In a situation where the aforementioned at least one CPU comprises a plurality of CPUs, the number of global busy level detectors may be the same as the number of CPUs, where the global busy level detectors are arranged to detect the global busy levels respectively corresponding to idle times of the CPUs, respectively. Please note that the global busy levels of some embodiments (e.g. some variations of the embodiment shown in FIG. 2) can be detected by observing clock(s) or observing transmission bandwidth (e.g. observing whether any data transmission operation exists and/or observing at least one duration of at least one data transmission operation). In some other examples, the global busy level may correspond to at least one idle time of the aforementioned at least one portion of the units 110, such as an idle time of the CPU, an overall idle time of all of the units 110 (e.g. an overall idle time when none of the units 110 is busy), or respective idle times of the units 110. In a situation where the global busy level corresponds to the respective idle times of the units 110, the units 110 may respectively report their idle times (and more particularly, the idle times when they are not using the CPU, respectively) to the global/local system performance manger 130 or the global/local system performance manger 130 can detect idle times of the units 110, and therefore, the global/local system performance manger 130 may determine the global busy level according to their idle times.

In practice, the aforementioned at least one global busy level detector such as the global busy level detector 120 can utilize a periodic/non-periodic measurement device (e.g. a timer) within the system 100 to detect or calculate the global busy level. In addition, the local busy level may correspond to a degree of data occupation in a storage module within the system 100, where the storage module is arranged to temporarily store data transmitted to/from/within at least one of the units. Please note that there are many choices regarding the implementation of the storage module. For example, the storage module can be a buffer. In another example, the storage module can be a queue. In another example, the storage module can be a first in first out (FIFO) storage (e.g. a FIFO memory), which can be simply referred to as a FIFO. In another example, the storage module can be a pipe. By properly associating a local busy level detector with a storage module corresponding to a unit of the system 100, the local busy level of the unit can be correctly detected or calculated.

According to a case of this embodiment, when the local busy level of a specific unit of the units 110 reaches a predetermined threshold and therefore indicates that increasing the operation frequency is required, the global/local system performance manger 130 can increase the operation frequency. More particularly, according to the priority of the specific unit among others, the global/local system performance manger 130 can determine whether to give consideration to the local busy level first. Thus, the global/local system performance manger 130 determines whether to give consideration to the local busy levels of some specific units of the units 110 according to the respective priorities of the specific units. For example, in a situation where a first unit corresponds to a higher priority than others, the global/local system performance manger 130 first utilizes the local busy level of the first unit to determine whether or how to change the operation frequency in this situation. In another example, in a situation where a first unit corresponds to a higher priority than others and the local busy level of the first unit indicates a different direction of changing (e.g. increasing or decreasing) the operation frequency, the global/local system performance manger 130 merely utilizes the local busy level of the first unit to determine whether or how to change the operation frequency in this situation. This is for illustrative purposes only, and is not meant to be a limitation of the present invention. According to variations of this embodiment, in a situation where a first unit corresponds to a higher priority than others and the global/local system performance manger 130 has already determined the required value of the operation frequency for the first unit, the global/local system performance manger 130 can set the operation frequency as the required value corresponding to the first unit.

According to different cases of this embodiment, the implementation of the aforementioned at least one operation frequency may vary. For example, the aforementioned at least one operation frequency may comprise at least one CPU operational frequency (e.g. at least one operational frequency of at least one CPU such as one or more CPUs) and/or at least one peripheral device operational frequency (e.g. at least one operational frequency of at least one peripheral device such as one or more peripheral devices). To adjust the operational frequency, a clock can be adjusted. For example, the CPU operational frequency can be adjusted by adjusting the clock provided to it; the peripheral device operational frequency can be adjusted by adjusting the clock provided to it. To save power and/or guarantee operations of the system, besides operational frequency, operational voltage can also be adjusted. For example, decreasing operational voltage may reduce power consumption, and increasing operational voltage may better guarantee operations of the system. In some embodiments, the operational voltages of the system and/or at least a portion of the units can be changed by adjusting at least one buck voltage (e.g. a voltage of a buck, which is a direct current (DC)-to-DC converter) and/or at least one low drop-out regulator (LDO) voltage (e.g. a voltage of an LDO) of the system and/or at least a portion of the units.

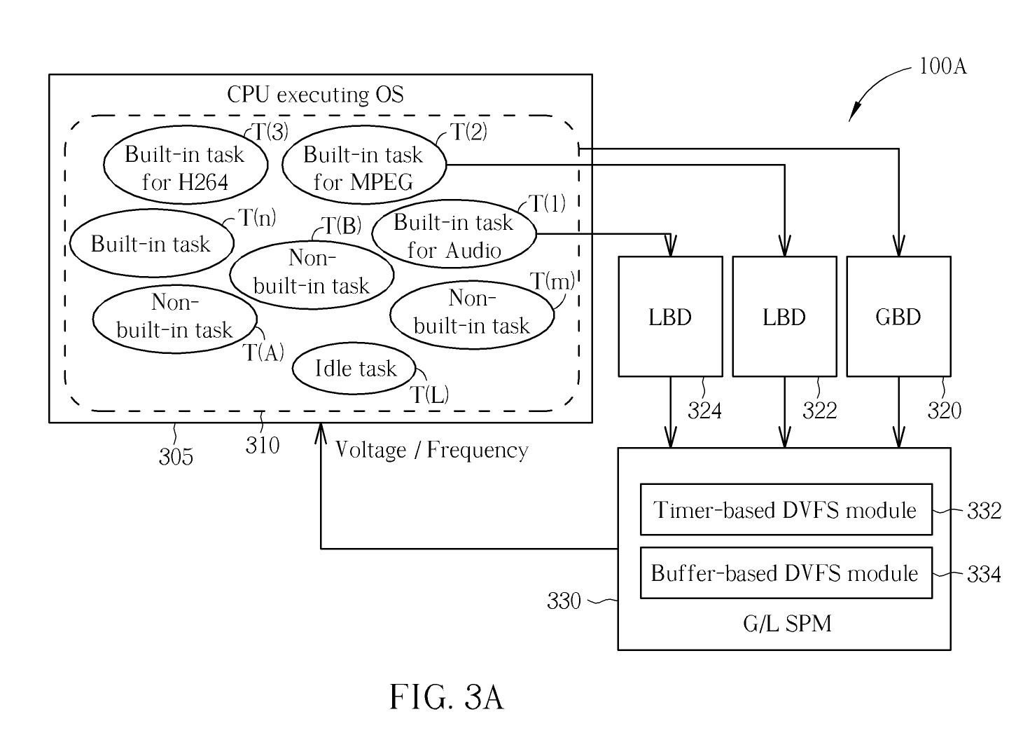

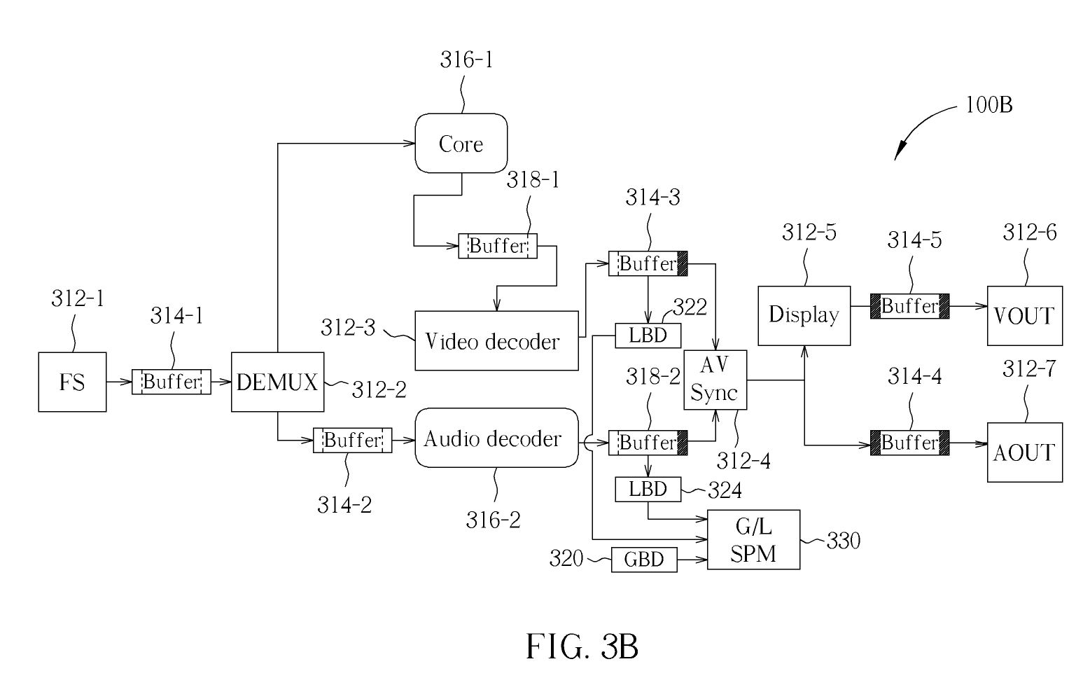

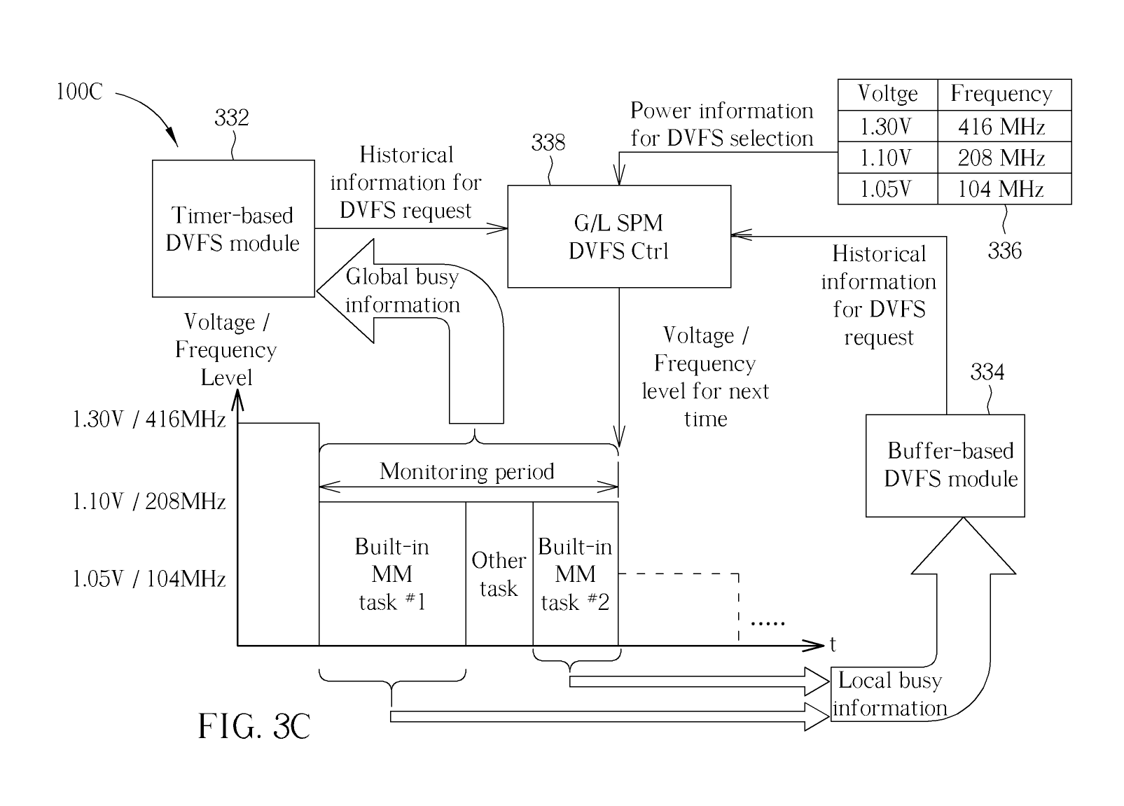

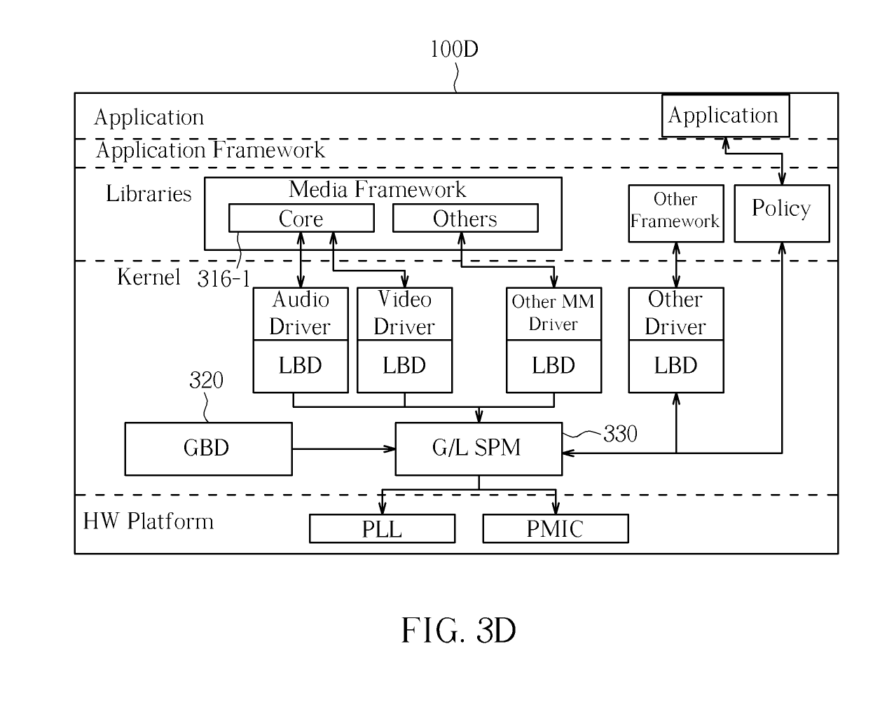

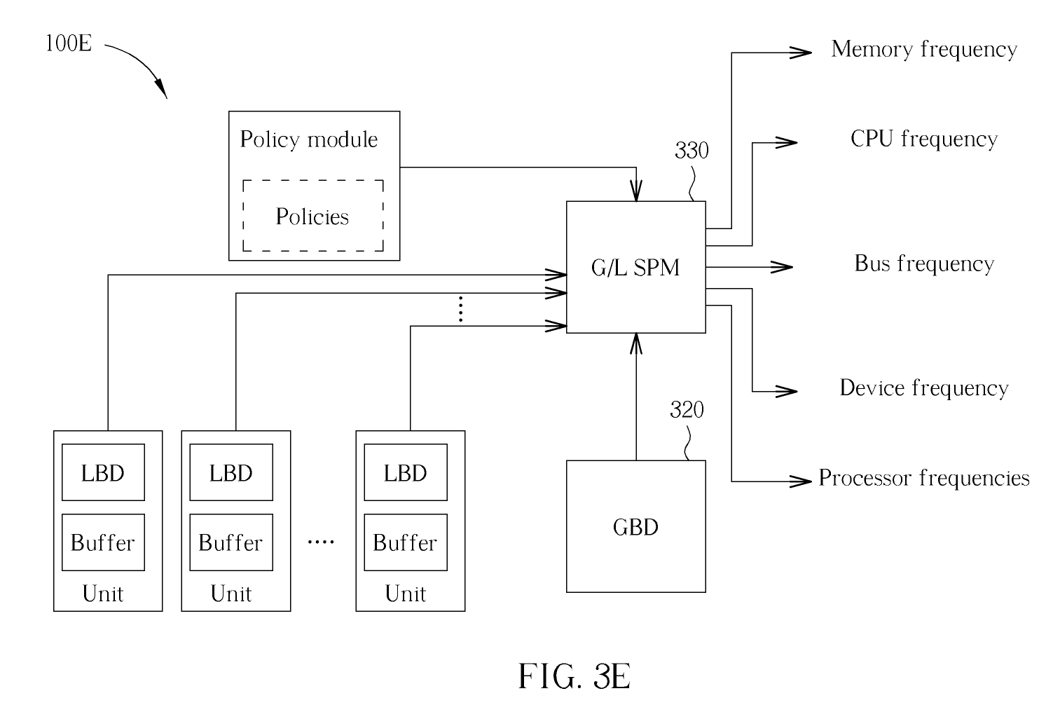

FIG. 3A illustrates some implementation details of the system 100 shown in FIG. 1 according to an embodiment of the present invention, where this embodiment is a variation of the embodiment shown in FIG. 1. The numeral 100 is replaced by 100A in response to the change in architecture. Here, the units of this embodiment comprise a plurality of software modules, such as a plurality of tasks 310, and more particularly, the built-in tasks T(1), T(2), T(3), and T(n) and the non-built-in tasks T(A), T(B), and T(m). The CPU 305 executing an operating system (OS) in run time may also execute the software modules such as the tasks 310. In addition, the global busy level detector 120 mentioned above can be replaced by the global busy level detector 320 (labeled “GBD” in FIG. 3A), and the local busy level detectors 122 and 124 can be replaced by the local busy level detectors 322 and 324 (respectively labeled “LBD” in FIG. 3A), where the local busy level detector 322 of this embodiment can be a local busy level detector for Moving Picture Experts Group (MPEG) processing, and the local busy level detector 324 of this embodiment can be a local busy level detector for audio processing. Additionally, the global/local system performance manger 130 can be replaced by the global/local system performance manger 330 (labeled “G/L SPM” in FIG. 3A). The operations of the system 100A are described as follows.

The global busy level detector 320 is arranged to detect a global busy level of the tasks 310, while the local busy level detector 322 is arranged to detect a local busy level of the built-in task T(2) for MPEG processing (labeled “Built-in task for MPEG”) and the local busy level detector 324 is arranged to detect a local busy level of the built-in task T(1) for audio processing (labeled “Built-in task for Audio”). In practice, the global busy level can be detected by measuring the idle duration(s) of the idle task T(L) within the tasks 310, and the local busy levels can be detected by measuring the throughput of respective output buffers associated with the built-in tasks T(1) and T(2). Here, when the idle task T(L) is executed, it means the system 100 is idle. More specifically, the idle task T(L) of this embodiment can be the idle task of the system 100. In addition, the global/local system performance manger 330 can re-arrange one or more tasks within/of the units to tune the performance of the system 100A.

Please note that, regarding the implementation of changing the aforementioned at least one operation frequency, such as one or more operation frequencies, a novel Dynamic Voltage and Frequency Scaling (DVFS) scheme which is different from any of the related art (if exists) is proposed, and can be applied to the system 100A. Based upon the aforementioned at least one global/local busy level (e.g. the global busy level from the global busy level detector 320, and the local busy levels respectively from the local busy level detectors 322 and 324) and the aforementioned at least one policy, the one or more operation frequencies can be adjusted, in order to tune the performance of the system 100A. As a result of applying the DVFS scheme of this embodiment to the system 100A, the one or more operation frequencies can be increased when needed, in order to guarantee operations of at least one portion of the units, or can be decreased when needed, in order to save power. This is for illustrative purposes only, and is not meant to be a limitation of the present invention. To adjust the operational frequency, a clock can be adjusted. For example, the operational frequency of CPU 305 can be adjusted by adjusting the clock provided to it; the operational frequencies of tasks 310 can be adjusted by adjusting the clocks provided to them respectively. To save power and/or guarantee operations of the system, besides operational frequency, operational voltage can also be adjusted. For example, decreasing operational voltage may reduce power consumption, and increasing operational voltage may better guarantee operations of the system. In some embodiments, the operational voltages of the system and/or at least a portion of the units can be changed by adjusting at least one buck voltage (e.g. a voltage of a buck, which is a direct current (DC)-to-DC converter) and/or at least one low drop-out regulator (LDO) voltage (e.g. a voltage of an LDO) of the system and/or at least a portion of the units.

In this embodiment, the global/local system performance manger 330 comprises a timer-based DVFS module 332 and a buffer-based DVFS module 334 for controlling the one or more operation frequencies. More particularly, the timer-based DVFS module is arranged to control the one or more operation frequencies according to the global busy level that is detected by measuring the idle duration(s) of the idle task in this embodiment, and the buffer-based DVFS module is arranged to control the one or more operation frequencies according to the local busy levels that are respectively detected by measuring the throughput of the associated output buffers.

Please note that, as long as the operations of the system 100A are not hindered, the associated implementation methods of some variations of the first embodiment, such as those disclosed above, can be applied to this embodiment, respectively. For brevity, similar descriptions are not repeated in detail for this embodiment.

FIG. 3B illustrates some implementation details of the system 100 shown in FIG. 1 according to an embodiment of the present invention, where this embodiment is a variation of the embodiment shown in FIG. 1, and is a variation of the embodiment shown in FIG. 3A. The numeral 100 is replaced by 100B in response to the change in architecture. Here, the units of this embodiment can comprise a plurality of hardware circuits, such as the front stage 312-1 (labeled “FS” in FIG. 3B), the demultiplexer 312-2 (labeled “DEMUX” in FIG. 3B), the video decoder 312-3, the audio/video synchronization circuit 312-4 (labeled “AV Sync” in FIG. 3B), the display circuit 312-5 (labeled “Display” in FIG. 3B), the video output circuit 312-6 (labeled “VOUT” in FIG. 3B), the audio output circuit 312-7 (labeled “AOUT” in FIG. 3B), and the buffers 314-1, 314-2, 314-3, 314-4, and 314-5 respectively associated with the front stage 312-1, the demultiplexer 312-2, the video decoder 312-3, the audio/video synchronization circuit 312-4, and the display circuit 312-5. In addition, the units of this embodiment can further comprise a plurality of software modules, such as the core module 316-1 (labeled “Core” in FIG. 3B) and the audio decoder 316-2, where the plurality of hardware circuits comprises the buffers 318-1 and 318-2 respectively associated with the core module 316-1 and the audio decoder 316-2. In particular, these buffers are FIFOs. This is for illustrative purposes only, and is not meant to be a limitation of the present invention. According to some variations of this embodiment, a portion of the units originally implemented with hardware circuits (e.g. the video decoder 312-3) can be implemented with software module(s), rather than hardware circuit(s). According to some variations of this embodiment, a portion of the units originally implemented with software modules (e.g. the audio decoder 316-2) can be implemented with hardware circuit(s), rather than software module(s).

The timer-based control mechanism of the global/local system performance manger 330 within the system 100B is similar to that of the system 100A, where the buffer-based control mechanism of the global/local system performance manger 330 within the system 100B is described as follows. The global/local system performance manger 330 can control at least a portion (e.g. a portion or all) of the front stage 312-1, the demultiplexer 312-2, the video decoder 312-3, the audio/video synchronization circuit 312-4, the display circuit 312-5, the video output circuit 312-6, the audio output circuit 312-7, the buffers 314-1, 314-2, 314-3, 314-4, and 314-5, the core module 316-1, the audio decoder 316-2, and the buffers 318-1 and 318-2. Referring to FIG. 3B, both sides of each of the buffers 314-1, 314-2, and 318-1 are not shaded, which means both of their data input speeds and data output speeds are not fixed. In addition, both sides of each of the buffers 314-4 and 314-5 are shaded, which means both of their data input speeds and data output speeds are fixed. Additionally, the input side of each of the buffers 314-3 and 318-2 are not shaded while the output side of each of the buffers 314-3 and 318-2 are shaded, which means their data input speeds are not fixed and their data output speeds are fixed. Thus, the buffers 314-3 and 318-2 can be regarded as real time (RT) critical buffers. In this embodiment, a typical reason why the buffers 314-3 and 318-2 can be regarded as RT critical buffers is that improper control of the buffers 314-3 and 318-2 may cause non-smooth audio/video playback and/or cause audio/video playback delay. For example, in a situation where one of the buffers 314-3 and 318-2 is temporarily empty (e.g. the data therein is used up) during audio/video playback, some abnormal playback phenomena may occur.

More specifically, the buffer 314-3 is a video RT critical buffer, and the buffer 318-2 is an audio RT critical buffer. According to this embodiment, the global busy level detector 320 is arranged to detect a global busy level of the at least one portion of the units in the system 100B, while the local busy level detector 322 is arranged to detect a local busy level of the buffer 314-3 and the local busy level detector 324 is arranged to detect a local busy level of the buffer 318-2. That is, both the local busy level detectors 322 and 324 are utilized for detecting the local busy levels of these RT critical buffers. During operations of the system 100B, in a situation where the occupancy of one or more RT critical buffers is larger than a predetermined threshold, the associated local busy levels may indicate that the aforementioned at least one operation frequency such as one or more operation frequencies can be decreased, and therefore, the global/local system performance manger 330 may decrease the one or more operation frequencies, in order to, for example, decrease the data input speeds of the one or more RT critical buffers. On the contrary, in a situation where the occupancy of one or more RT critical buffers is less than a predetermined threshold, the associated local busy levels may indicate that the aforementioned at least one operation frequency such as one or more operation frequencies can be increased, and therefore, the global/local system performance manger 330 may increase the one or more operation frequencies, in order to, for example, increase the data input speeds of the one or more RT critical buffers. This is for illustrative purposes only, and is not meant to be a limitation of the present invention. According to some variations of this embodiment, the global/local system performance manger 330 determines whether to increase/decrease the one or more operation frequencies according to data input/output speeds of the RT critical buffers, rather than the occupancy of any RT critical buffer. For example, regarding a specific RT critical buffer of the RT critical buffers, when the data input speed is greater than the data output speed plus a predetermined value (e.g. a positive predetermined value), the global/local system performance manger 330 may decrease the one or more operation frequencies, in order to, for example, decrease the data input speed of the specific RT critical buffer. In another example, regarding a specific RT critical buffer of the RT critical buffers, when the data input speed is less than the data output speed minus a predetermined value (e.g. a positive predetermined value, such as that mentioned above), the global/local system performance manger 330 may increase the one or more operation frequencies, in order to, for example, increase the data input speed of the specific RT critical buffer.

Thus, by utilizing the buffer-based control mechanism corresponding to the local busy levels and the timer-based control mechanism corresponding to the global busy level, the performance of the system 100B can be tuned properly. Based upon the aforementioned at least one global/local busy level (e.g. the global busy level from the global busy level detector 320, and the local busy levels respectively from the local busy level detectors 322 and 324) and the aforementioned at least one policy, the one or more operation frequencies can be optimized, in order to tune the performance of the system 100B. As a result of applying the DVFS scheme of this embodiment to the system 100B, the one or more operation frequencies can be increased when needed, in order to guarantee operations of at least one portion of the units, or can be decreased when needed, in order to save power.

Please note that, as long as the operations of the system 100B are not hindered, the associated implementation methods of some variations of the first embodiment, such as those disclosed above, can be applied to this embodiment, respectively. For brevity, similar descriptions are not repeated in detail for this embodiment.

FIG. 3C illustrates some implementation details of the system 100 shown in FIG. 1 according to an embodiment of the present invention, where this embodiment is a variation of the embodiment shown in FIG. 1, and is a variation of any of the embodiments respectively shown in FIG. 3A and FIG. 3B. The numeral 100 is replaced by 100C in response to the change in architecture.

Some built-in multimedia tasks such as the built-in multimedia task #1 (labeled “Built-in MM task #1” in FIG. 3C) and the built-in multimedia task #2 (labeled “Built-in MM task #2” in FIG. 3C) are taken as examples of the tasks 310. In this embodiment, the built-in multimedia task #1, the built-in multimedia task #2, and some other task(s) do not exist at the same time. This is for illustrative purposes only, and is not meant to be a limitation of the present invention. According to some variations of this embodiment, the built-in multimedia task #1, the built-in multimedia task #2, and some other task(s) may exist at the same time. According to some variations of this embodiment, at least a portion (e.g. a portion or all) of the built-in multimedia task #1, the built-in multimedia task #2, and some other task(s) may be in a suspended mode. Referring to FIG. 3C, the voltage and frequency levels that are available are illustrated around the vertical axis, while the horizontal axis represents the time axis. The timer-based DVFS module 332 gathers global busy information to perform timer-based workload prediction and therefore detects or calculates the global busy level. As shown in FIG. 3C, a time period between the beginning time point of the built-in multimedia task #1 and the end time point of the built-in multimedia task #2 is taken as an example of the monitoring period for detecting or calculating the global busy level. In addition, the buffer-based DVFS module 334 gathers local busy information to perform buffer-based workload prediction and therefore detects or calculates the local busy levels. In this embodiment, the global/local system performance manger 330 comprises a DVFS control module 338 (labeled “G/L SPM DVFS Ctrl” in FIG. 3C), where a table 336 listing the voltage and frequency levels that are available can be provided within or outside the global/local system performance manger 330. The DVFS control module 338 may obtain power information for DVFS selection from the table 336, and may further obtain historical information for DVFS requests from the timer-based DVFS module 332 and the buffer-based DVFS module 334, respectively. Please note that closed-loop control can be implemented by utilizing the historical information. This is for illustrative purposes only, and is not meant to be a limitation of the present invention. According to some variations of this embodiment, open-loop control can be implemented by omitting the historical information. In general, according to any of this embodiment and the variations thereof, based upon the power information for DVFS selection (e.g. the contents of the table 336), the global busy level from the timer-based DVFS module 332, the local busy levels from the buffer-based DVFS module 334, and optionally the historical information for DVFS requests from the timer-based DVFS module 332 and the buffer-based DVFS module 334, the DVFS control module 338 can decide the voltage and/or frequency levels for the next time.

Please note that, as long as the operations of the system 100C are not hindered, the associated implementation methods of some variations of the first embodiment, such as those disclosed above, can be applied to this embodiment, respectively. For brevity, similar descriptions are not repeated in detail for this embodiment.

FIG. 3D illustrates some implementation details of the system 100 shown in FIG. 1 according to an embodiment of the present invention, where this embodiment is a variation of the embodiment shown in FIG. 1, and is a variation of any of the embodiments respectively shown in FIGS. 3A-3C. The numeral 100 is replaced by 100D in response to the change in architecture. In particular, the system 100D can be utilized for implementing a low power architecture.

As shown in FIG. 3D, the system 100D can be divided into a plurality of layers, where the layers comprise an application layer, an application framework layer, a library layer, a kernel layer, and a hardware platform layer (respectively labeled “Application”, “Application Framework”, “Libraries”, “Kernel”, and “HW Platform” in FIG. 3D). One or more applications may exist in the application layer. As shown in FIG. 3D, the library layer may comprise a media framework (labeled “Media Framework” in FIG. 3D) comprising the core module 316-1 and other modules available (respectively labeled “Core” and “Others” in FIG. 3D), and may further comprise one or more other frameworks and a policy module (respectively labeled “Other Framework” and “Policy” in FIG. 3D). In addition, the kernel layer may comprise an audio driver, a video driver, other multimedia drivers (labeled “Other MM Driver” in FIG. 3D), and other drivers, where these drivers can be regarded as the units mentioned above. The notations “PLL” and “PMIC” respectively represent some hardware circuits in the hardware platform layer. Additionally, the notations “GBD” and “LBD” respectively represent the aforementioned global busy level detector and the aforementioned local busy level detectors, where each of the drivers of this embodiment has an associated local busy level detector.

Please note that, as long as the operations of the system 100D are not hindered, the associated implementation methods of some variations of the first embodiment, such as those disclosed above, can be applied to this embodiment, respectively. For brevity, similar descriptions are not repeated in detail for this embodiment.

FIG. 3E illustrates some implementation details of the system 100 shown in FIG. 1 according to an embodiment of the present invention, where this embodiment is a variation of the embodiment shown in FIG. 1, and is a variation of any of the embodiments respectively shown in FIGS. 3A-3D. The numeral 100 is replaced by 100E in response to the change in architecture.

In this embodiment, the aforementioned at least one operation frequency may comprise a plurality of operation frequencies, such as a memory frequency of a memory, a CPU frequency of the CPU 305, a bus frequency of a bus, device frequencies of one or more devices, and processor frequencies of one or more processors. The global busy level detector 320 (labeled “GBD” in FIG. 3E) can be implemented as an OS scheduler. In addition, the units of this embodiment may comprise software applications, drivers, and/or hardware devices. The local busy level detectors (respectively labeled “LBD” in FIG. 3E) can detect the local busy levels of the respective units of the system 100E, and more particularly, the associated local busy levels corresponding to the buffers of these units in the system 100E. Additionally, the timer-based control mechanism of the global/local system performance manger 330 within the system 100E is similar to that of the system 100A, and the buffer-based control mechanism of the global/local system performance manger 330 within the system 100E is similar to that of the system 100B.

Please note that, as long as the operations of the system 100E are not hindered, the associated implementation methods of some variations of the first embodiment, such as those disclosed above, can be applied to this embodiment, respectively. For brevity, similar descriptions are not repeated in detail for this embodiment.

According to a variation of the embodiment shown in FIG. 3E, the system 100 can be a distributed system comprising a plurality of personal computers, each of which operates according to one or more operation frequencies such as those of the system 100E shown in FIG. 3E. Similar descriptions are not repeated in detail for this variation.

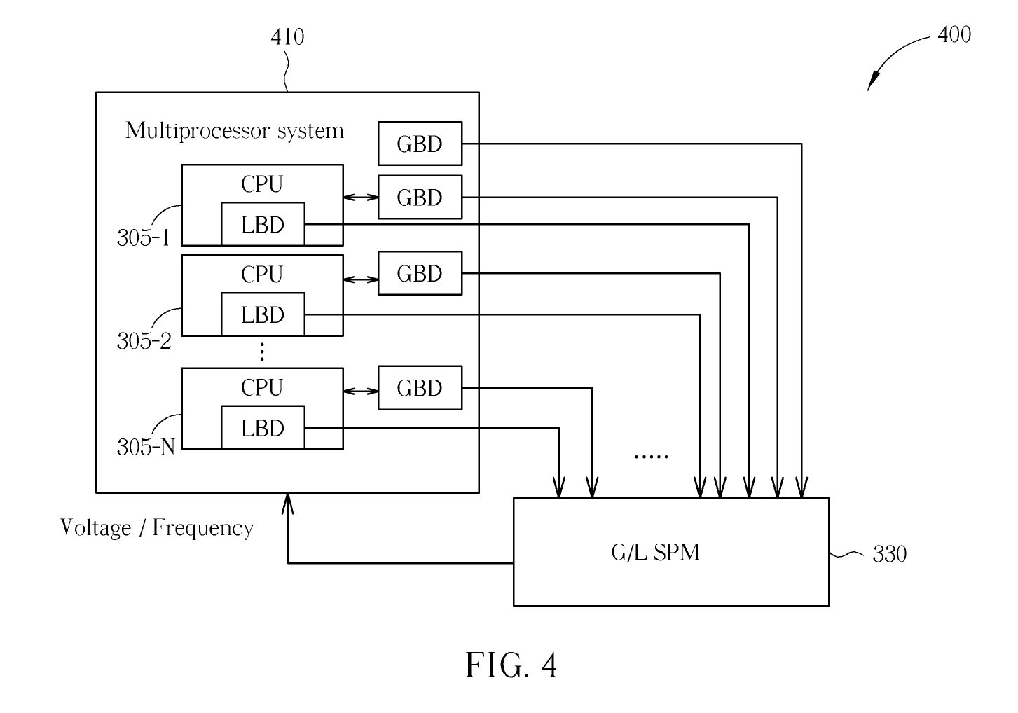

FIG. 4 illustrates some implementation details of the system 100 shown in FIG. 1 according to an embodiment of the present invention, where this embodiment is a variation of the embodiment shown in FIG. 1, and is a variation of any of the embodiments respectively shown in FIGS. 3A-3E. The numeral 100 is replaced by 400 in response to the change in architecture. As shown in FIG. 4, the system 400 comprises a multiprocessor system 410.

In this embodiment, the units mentioned above may comprise a plurality of CPUs, such as the CPUs 305-1, 305-2, . . . , and 305-N within the multiprocessor system 410. The local busy level detectors (respectively labeled “LBD” in FIG. 4) detect respective local busy levels inside the CPUs 305-1, 305-2, . . . , and 305-N, and the global busy level detectors (respectively labeled “GBD” in FIG. 4) detect some global busy levels of the CPUs 305-1, 305-2, . . . , and 305-N, where some of the global busy level detectors are coupled to the CPUs 305-1, 305-2, . . . , and 305-N, and therefore, can interact with the CPUs 305-1, 305-2, . . . , and 305-N. In this embodiment, the global busy level detectors (respectively labeled “GBD” in FIG. 4) can detect the respective global busy levels of the CPUs 305-1, 305-2, . . . , and 305-N by detecting idle times of the CPUs 305-1, 305-2, . . . , and 305-N, respectively. In addition, the CPUs 305-1, 305-2, . . . , and 305-N can be passively under detection of the global busy level detectors. This is for illustrative purposes only, and is not meant to be a limitation of the present invention. According to some variations of this embodiment, the global busy level detectors can detect the respective global busy levels of the CPUs 305-1, 305-2, . . . , and 305-N by observing idle tasks of the CPUs 305-1, 305-2, . . . , and 305-N, respectively. For example, at least a portion (e.g. a portion or all) of the CPUs 305-1, 305-2, . . . , and 305-N can be passively under detection of the global busy level detectors. In another example, at least a portion (e.g. a portion or all) of the CPUs 305-1, 305-2, . . . , and 305-N can actively report their busy levels to the corresponding global busy level detectors.

In addition, the timer-based control mechanism of the global/local system performance manger 330 within the system 400 is similar to that of the system 100A, and the buffer-based control mechanism of the global/local system performance manger 330 within the system 400 is similar to that of the system 100B.

Please note that, as long as the operations of the system 400 are not hindered, the associated implementation methods of some variations of the first embodiment, such as those disclosed above, can be applied to this embodiment, respectively. For brevity, similar descriptions are not repeated in detail for this embodiment.

It is an advantage of the present invention that, based upon the aforementioned at least one global/local busy level and the aforementioned at least one policy, the aforementioned at least one parameter such as the aforementioned at least one operation frequency can be adjusted, in order to tune the performance of the system. In addition, according to some embodiments, the aforementioned at least one operation frequency such as one or more operation frequencies can be increased when needed, in order to guarantee operations of at least one portion of the units, or can be decreased when needed, in order to save power.

Those skilled in the art will readily observe that numerous modifications and alterations of the device and method may be made while retaining the teachings of the invention.

What is claimed is:

1. A system having tunable performance, the system comprising:
a plurality of units, wherein at least one unit of the plurality of units comprises a hardware circuit;
at least one global/local busy level detector comprising at least one global busy level detector and/or at least one local busy level detector, wherein each global/local busy level detector is arranged to detect a global/local busy level of at least one portion of the units; and
a global/local system performance manger arranged to tune the performance of the system according to at least one global/local busy level detected by the at least one global/local busy level detector, wherein based upon the at least one global/local busy level and at least one policy associated with the performance of the system, the global/local system performance manger adjusts at least one parameter of the system when needed, in order to save power and/or guarantee operations of the system, and the at least one parameter corresponds to the performance of the system.

2. The system of claim 1, wherein at least one unit of the plurality of units comprises a software module.

3. The system of claim 1, wherein the at least one parameter comprises at least one operation frequency of the system; based upon the at least one global/local busy level and the at least one policy, the global/local system performance manger decreases the at least one operation frequency when needed, in order to save power; and based upon the at least one global/local busy level and the at least one policy, the global/local system performance manger increases the operation frequency when needed, in order to guarantee operations of the system.

4. The system of claim 3, wherein the at least one policy comprises a plurality of policies; and in accordance with at least a portion of the policies, the global/local system performance manger dynamically keeps the operation frequency at an optimal value thereof.

5. The system of claim 3, wherein in accordance with at least a portion of the at least one policy, the global/local system performance manger temporarily keeps the operation frequency at a target value; and the target value is a maximum of respective required values of the operation frequency for at least a portion of the units.

6. The system of claim 3, wherein in accordance with at least a portion of the at least one policy, the global/local system performance manger temporarily keeps the operation frequency at a target value; and the target value is a sum of respective required values of the operation frequency for at least a portion of the units.

7. The system of claim 1, wherein in accordance with at least a portion of the at least one policy, the global/local system performance manger temporarily minimizes power consumption of the units without hindering operations of at least a portion of the units.

8. The system of claim 1, wherein the at least one parameter comprises at least one operation frequency of the system; and in accordance with at least a portion of the at least one policy, the global/local system performance manger temporarily keeps the operation frequency at a maximal value available.

9. The system of claim 1, wherein the at least one global/local busy level detector comprises at least one global busy level detector arranged to detect a global busy level of the at least one portion of the units; and the at least one portion of the units comprises a central processing unit (CPU).

10. The system of claim 9, wherein the at least one global/local busy level detector comprises a local busy level detector; and the local busy level detector is temporarily disabled, and/or the global/local system performance manger temporarily operates without utilizing any local busy level from the local busy level detector.

11. The system of claim 9, wherein the global busy level corresponds to an idle time of the CPU.

12. The system of claim 9, wherein the global busy level corresponds to at least one idle time of the at least one portion of the units.

13. The system of claim 9, wherein the at least one global busy level detector utilizes a periodic/non-periodic measurement device within the system to detect or calculate the global busy level.

14. The system of claim 1, wherein the at least one global/local busy level detector comprises at least one local busy level detector arranged to detect a local busy level of a specific unit of the units.

15. The system of claim 14, wherein the at least one global/local busy level detector comprises a global busy level detector; and the global busy level detector is temporarily disabled, and/or the global/local system performance manger temporarily operates without utilizing any global busy level from the global busy level detector.

16. The system of claim 14, wherein the local busy level corresponds to a degree of data occupation in a storage module within the system; and the storage module is arranged to temporarily store data transmitted to/from/within at least one of the units.

17. The system of claim 16, wherein the storage module is a buffer, a queue, a first in first out (FIFO), or a pipe.

18. The system of claim 14, wherein the at least one parameter comprises at least one operation frequency of the system; and the at least one operation frequency comprises at least one central processing unit (CPU) operational frequency and at least one peripheral device operational frequency.

19. The system of claim 14, wherein the at least one parameter comprises at least one operation frequency of the system; and when the local busy level reaches a predetermined threshold and therefore indicates that increasing the operation frequency is required, the global/local system performance manger increases the operation frequency.

20. The system of claim 19, wherein according to a priority of the specific unit among others, the global/local system performance manger determines whether to give consideration to the local busy level first.

21. The system of claim 1, wherein the global/local system performance manger re-arranges one or more tasks within/of the units to tune the performance of the system.

22. The system of claim 1, wherein the system is a symmetric multiprocessing (SMP) system, an asymmetric multiprocessing (AMP) system, or a distributed system.

23. The system of claim 1, wherein the at least one parameter comprises at least one bandwidth of the at least one portion of the units; and the at least one bandwidth corresponds to time of using a central processing unit (CPU) within the system by the at least one portion of the units, respectively.

24. A method for tuning performance of a system, the method comprising:
detecting at least one global/local busy level of at least one portion of a plurality of units of the system, wherein at least one unit of the plurality of units comprises a hardware circuit; and
tuning the performance of the system according to the at least one global/local busy level, wherein the step of tuning the performance of the system according to the at least one global/local busy level further comprises:
based upon the at least one global/local busy level and at least one policy associated with the performance of the system, adjusting at least one parameter of the system when needed, in order to save power and/or guarantee operations of the system, wherein the at least one parameter corresponds to the performance of the system.

25. The method of claim 24, wherein at least one unit of the plurality of units comprises a software module.

26. The method of claim 24, wherein the at least one parameter comprises at least one operation frequency of the system; and the step of tuning the performance of the system according to the at least one global/local busy level further comprises:
based upon the at least one global/local busy level and the at least one policy, decreasing the at least one operation frequency when needed, in order to save power; and
based upon the at least one global/local busy level and the at least one policy, increasing the operation frequency when needed, in order to guarantee operations of the system.

27. The method of claim 26, wherein the at least one policy comprises a plurality of policies; and the method further comprises:
in accordance with at least a portion of the policies, dynamically keeping the operation frequency at an optimal value thereof.

28. The method of claim 26, further comprising:
in accordance with at least a portion of the at least one policy, temporarily keeping the operation frequency at a target value, wherein the target value is a maximum of respective required values of the operation frequency for at least a portion of the units.

29. The method of claim 26, further comprising:
in accordance with at least a portion of the at least one policy, temporarily keeping the operation frequency at a target value, wherein the target value is a sum of respective required values of the operation frequency for at least a portion of the units.

30. The method of claim 24, further comprising:
in accordance with at least a portion of the at least one policy, temporarily minimizing power consumption of the units without hindering operations of at least a portion of the units.

31. The method of claim 24, wherein the at least one parameter comprises at least one operation frequency of the system; and the method further comprises:
in accordance with at least a portion of the at least one policy, temporarily keeping the operation frequency at a maximal value available.

32. The method of claim 24, wherein the step of detecting the at least one global/local busy level further comprises:
detecting a global busy level of the at least one portion of the units, wherein the at least one portion of the units comprises a central processing unit (CPU).

33. The method of claim 32, further comprising:
temporarily operating without utilizing any local busy level.

34. The method of claim 32, wherein the global busy level corresponds to an idle time of the CPU.

35. The method of claim 32, wherein the global busy level corresponds to at least one idle time of the at least one portion of the units.

36. The method of claim 32, wherein the step of detecting the global busy level of the at least one portion of the units further comprises:
utilizing a periodic/non-periodic measurement device within the system to detect or calculate the global busy level.

37. The method of claim 24, the step of detecting the at least one global/local busy level further comprises:
detecting a local busy level of a specific unit of the units.

38. The method of claim 37, further comprising:
temporarily operating without utilizing any global busy level.

39. The method of claim 37, wherein the local busy level corresponds to a degree of data occupation in a storage module within the system; and the storage module is arranged to temporarily store data transmitted to/from/within at least one of the units.

40. The method of claim 39, wherein the storage module is a buffer, a queue, a first in first out (FIFO), or a pipe.

41. The method of claim 37, wherein the at least one parameter comprises at least one operation frequency of the system; and the at least one operation frequency comprises at least one central processing unit (CPU) operational frequency and at least one peripheral device operational frequency.

42. The method of claim 37, wherein the at least one parameter comprises at least one operation frequency of the system; and the method further comprises:
when the local busy level reaches a predetermined threshold and therefore indicates that increasing the operation frequency is required, increasing the operation frequency.

43. The method of claim 42, further comprising:
according to a priority of the specific unit among others, determining whether to give consideration to the local busy level first.

44. The method of claim 24, further comprising:
re-arranging one or more tasks within/of the units to tune the performance of the system.

45. The method of claim 24, wherein the system is a symmetric multiprocessing (SMP) system, an asymmetric multiprocessing (AMP) system, or a distributed system.

46. The method of claim 24, wherein the at least one parameter comprises at least one bandwidth of the at least one portion of the units; and the at least one bandwidth corresponds to time of using a central processing unit (CPU) within the system by the at least one portion of the units, respectively.
